(19) United States
(12) Patent Application Publication
(10) Pub. No.: US 2015/0116552 A1
(43) Pub. Date: Apr. 30, 2015

(54) Digital camera system and a method for controlling the digital camera system

(71) Applicant: Jan KÅHRE, Helsinki (FI)

(72) Inventor: Jan KÅHRE, Helsinki (FI)

(21) Appl. No.: 14/526,557

(22) Filed: Oct. 29, 2014

(30) Foreign Application Priority Data
Oct. 30, 2013 (FI) 20136059

(51) Int. Cl. H04N 5/232; H04N 5/14

(52) U.S. Cl. CPC H04N 5/23212; H04N 5/142
USPC 348/252

(57) ABSTRACT

The present invention relates to a digital camera system comprising an image sensor for capturing digital images, an optical unit for forming an image onto the image sensor, the optical unit having a focus distance that can be varied between a minimum focus distance and a maximum focus distance, a control module for controlling the image sensor and the optical unit, an image processing module for processing captured images, and an image storage for storing captured images. The control module is configured to, upon receiving an order to capture an image, order the image sensor to capture a sequence of images while varying the focus distance between a first and a second focus distance and to store the sequence of captured images in the image storage, and the image processing module is configured to evaluate said sequence of images with regard to a defined criterion, to select at least one images from the sequence of images based on the result of the evaluation.

### FIELD OF INVENTION

The present invention relates to a digital camera system comprising an image sensor for capturing digital images and an optical unit for forming an image onto the image sensor, the optical unit having a focus distance that can be varied between a minimum focus distance and a maximum focus distance. The present invention also relates to a method for controlling a digital camera system.

### BACKGROUND ART

Digital cameras use a lens to focus a scene onto an image sensor. To save costs some digital cameras has a fixed focus lens. However, many digital cameras include an adjustable focus setting. Cameras including an adjustable focus setting may include a manual focus system that enable a user to manually adjust the focus setting, or an auto-focusing system which can automatically adjust the focus setting of the lens to achieve focus on main subjects in the scene. The auto-focusing systems can either be active or passive. An active auto-focusing system sends out a signal, for example sound waves or infra red light and determines the distance to an object based on the reflected signal. A passive auto-focusing system senses light from the environment and mathematically analyses the sensed light and based thereon calculates the focus distance. Today, the passive auto-focusing systems are the most used auto-focusing systems. Some passive auto-focusing systems use the image sensor of the camera to capture test images that are used to determine the focus distance.

US2013/0135516 discloses an auto-focusing controlling apparatus including a focus evaluation value generating device generating a focus evaluation value based on image data acquired through the focus lens, a target lens position determining device determining a target lens position, a timing determining device determining a plurality of acquisition lens positions for acquiring the focus evaluation values in a scanning direction from a present lens position of the focus lens towards the target lens position, a scanning device driving the focus lens in the scanning direction, a predicted focus lens positioning determining device predicting a predicted focus lens position based on the acquired focus evaluation values and a moving device stopping the scanning device to drive the focus when the predicted focus lens position is determined and to move the focus lens to the predicted focus lens position.

### SUMMARY OF INVENTION

### Technical Problem

A problem with most auto-focusing systems is that it takes time to find a suitable focus distance, and accordingly it takes time before the photo can be captured. This is particularly a problem when capturing photos of moving objects, such children.

Further, there is a problem with existing auto-focusing systems if there are two or more objects in the scene positioned at different distances from the camera. Only one of the objects can be sharply reproduced, and the other objects are more or less blurry reproduces in the image. It may also be difficult for the auto-focusing systems to be sure of which of the objects to be focused on. It happens rather often that the system focus on another object than the object which was intended by the user to be focused on.

### Solution to Problem

The object of the present invention is to provide an improved digital camera system that alleviates at least one of the above mentioned problems.

The present digital camera system typically comprises an image sensor for capturing digital images, an optical unit for forming an image onto the image sensor, the optical unit having a focus distance that can be varied between a minimum focus distance and a maximum focus distance, a control module for controlling the image sensor and the optical unit, a image processing module for processing captured images, and an image storage for storing captured images.

According to the invention, the control module is configured and operated in such a way that the image sensor is order to capture a sequence of images while varying the focus distance between a first and a second focus distance and to store the sequence of captured images in the image storage. The image processing module is configured to evaluate said sequence of images with regard to a defined criterion, and to select at least one image from said sequence of images based on the result of the evaluation.

More specifically, the present camera device is characterized by what is stated in the characterizing part of claim 1.

The method of controlling a digital camera system is characterized by what is stated in the characterizing part of claim 11.

### Advantageous Effects of Invention

A plurality of images of the same scene is captured at different focus distances. By selecting at least on image from the captured sequence of images based on a certain criterion, it is possible to select an image that fulfills the defined criterion. Since the images are captures at different focus distances it is not necessary to carry out any auto focusing. Thus, a digital camera according to the invention can be dispensed with the auto focusing system.

Another advantage gained with the present invention is that the images are captures faster due to the fact that the image processing is carried out afterwards, instead of before as in the prior art.

### BRIEF DESCRIPTION OF DRAWINGS

The present technology will now be explained more closely by the description of different embodiments and with reference to the appended figures, wherein

FIG. 1 shows a digital camera system according to an embodiment of the invention;

FIG. 2 shows an example of an image created based on a sequence of captured images; and

FIG. 3 shows a flow chart of a method for controlling a digital camera system according to an embodiment of the invention.

### DESCRIPTION OF EMBODIMENTS

As discussed above, in the present new technology, by using a digital camera system,
a sequence of images is captured while varying the focus distance between a first and a second focus distance;
the sequence of images is evaluated with regard to a defined criterion; and
at least one image is selected from the sequence of images based on the result of the evaluation and the criterion.

For that purpose, the digital camera system comprises a control module, and an image processing module. The control module is configured to, upon receiving an order to capture an image, order the image sensor to capture a sequence of images while varying the focus distance between a first and a second focus distance and to store the sequence of captured images in the image storage. The image processing module is configured to evaluate said sequence of images with regard to a defined criterion.

The first and second focus distances differ from each other. For example, the first focus distance is closer to the camera than the second focus distance. Preferably, the sequence of images is captured while varying the focus distance between a minimum focus distance and a maximum focus distance of the camera. Thus, a plurality of images of the same scene is captured at different focus distances.

For example, the sequence of images is evaluated with regard to the sharpness of the images, and the sharpest image is selected. The selected image is stored and displayed to the user as the captured image

According to an embodiment of the invention, the image processing module is configured to select a plurality of images from said sequence of images based on the result of the evaluation and the defined criterion, and to create a new image based on the selected images.

By selecting a plurality of images from the captured sequence of images based on a certain criterion, it is possible to uses information from the selected images to create a new improved image that fulfills the defined criterion. The new improved image is stored on the camera as the captured image. The quality of the new image is improved compared to the quality of each of the images in the sequence of captured images. Thus, the digital camera according to the invention improves the quality of the captures images. Since the images are captures at different focus distances it is not necessary to carry out any auto focusing. Thus, a digital camera according to the invention can be dispensed with the auto focusing system.

According to an embodiment of the invention, the criterion is a criterion for the sharpness of the images. The image processing module is configured to evaluate the images with regard to the sharpness of the images and, to determine whether the images fulfill the defined criterion for the sharpness. Thus, the digital camera according to the invention improves the sharpness of the captures images. This embodiment of the invention enables several objects in the scene positioned at different distances from the camera to be sharply reproduced.

According to an embodiment of the invention, the image processing module is configured to determine the sharpness of the images, and said criterion is fulfilled if the sharpness exceeds a threshold value. This embodiment improves the sharpness of the captured image.

According to an embodiment of the invention, the image processing module is configured to divide at least some of the images from the sequence of images into a number of image portions, to evaluate the image portions with regard to said defined criterion, to select image portions from said sequence of captured images that fulfill the criterion, and to create a new image based on the selected images portions. The new image is created based on selected image portions from different images in the sequence. By dividing the images taken at different focus distances into image portions, selecting image portions from different images in the sequence, which selected image portions fulfill a certain criterion, and put together the selected portions into a new image of the same scene, it is possible to improve the quality of the captured image. For example, it is possible to select the portions with regard to the sharpness of the image portions and put together to a new image having an improved sharpness compared to all of the captured images in the sequence. Thus, it is possible to create an image with objects positioned at different distances from the camera, where all of the objects are sharply reproduced. This embodiment solves the above mentioned problems with the prior art auto focusing systems.

According to an embodiment of the invention, the image processing module is configured to compare corresponding image portions of the images in the sequence with regard to the sharpness of the portions, and said criterion includes selecting the sharpest image portion of the compared corresponding image portions. This embodiment further improves the sharpness of the created image.

According to an embodiment of the invention, the image processing module is configured to divide each of said images into a number of portions to form a mosaic of image portions and to put the selected images portions together to form a new image. For example, the image portions are equally sized.

According to an embodiment of the invention, the number of images in the sequence is at least three, and each image is divided into at least nine image portions. A large number of images and a large number of image portions improve the quality of the created image.

According to an embodiment of the invention, the image processing module is configured to determine the sharpness of said image portions, to assign each image portion a weight factor in dependence on the determined sharpness, and to select the image portions based on the weight factors. This embodiment makes it possible to adjust the differences in sharpness between different potions of the image.

According to an embodiment of the invention, the image processing module is configured to evaluate and select the images while capturing the sequence of images. Thus, memory usage can be saved and the time for carrying out the image processing can be reduces. It is a further object of the present invention to provide an improve method for controlling a digital camera system.

Turning now to the drawings, it can be noted that FIG. 1 shows a digital camera system according to an interested embodiment of the present technology.

The digital camera system comprises an image sensor 1 for capturing digital images and an optical unit for forming an image onto the image sensor with a variable focus. The optical unit includes an adjustable lens 2 and a focus driver 3 arranged to control the lens 1 so that a focus distance of the lens can be varied between a minimum focus distance and a maximum focus distance. The digital camera system further comprises an adjustable shutter 4 forming an aperture for permitting light to enter into the camera. The focus driver 3 includes a motor for adjusting the position of the lens 2 relative the shutter 4 and the image sensor 1, thereby varying the focus distance of the digital camera. The lens 2 focuses light from the aperture of the shutter 4 onto the image sensor 1. The image sensor 1 is, for example, a single chip color CCD or CMOS image sensor. The output from the sensor is converted to digital form by an Analog to Digital converter 6 and is stored in image storage 7. The image storage is, for example, RAM.

The digital camera system further comprises a data processing system 10 including data processing means (not shown) such as CPU, FPGA, or similar hardware, and program memory (not shown) such as ROM, PROM or Flash memory, communicatively connected to the data processing means and storing software instructions configured to cause the data processing system to implement a method for providing improved digital images according to the invention. Appropriate data processing hardware for digital cameras is well known by the skilled person and will thus not be explained in more detail.

The data processing system 10 includes a control module 12 for controlling the image sensor 1, the focus driver 3 and the shutter 4. The data processing system 10 further includes an image processing module 14 for processing captured images. The control module 12 and the image processing module 14 are, for example, implemented by means of software running on a processor of the data processing system 10, or firmware programmed on hardware.

The digital camera system further comprises a user interface 16 for interacting with a user such as receiving instructions from the user regarding capturing of an image and for displaying captured images to the user. The user interface may include a display unit, for example a touch screen, and a button for ordering capture of an image. The control module 12 is in communication with the user interface 16, the focus driver 3 and the image sensor 1. The control module 12 is notified when the user interface 16 receives instructions from a user regarding an order to capture an image. In response to receiving the instructions to capture an image, the control module 12 sends an order to the image sensor 1 to capture a sequence of images. The images are captured during a very short time period. During the same time period, the control module 12 controls the movements of the focus driver so that the focus distance is varied between a first and a second focus distance while the images are captured.

Thus, a sequence of images of the same scene is captured with different focus distances. The first and second focus distances depend on the design of the optical unit of the digital camera. For example, the first focus distance is the minimum focus distance of the camera and the second focus distance is the maximum focus distance of the camera. Preferably, the number of images in the sequence is at least three. More preferably, the number of images in the sequence is at least five and most preferably, the number of images in the sequence is at least ten. The sequence of captured images is stored in the image storage 7.

The image processing module 14 is configured to evaluate the sequence of images with regard to a defined criterion, preferably a criterion for the sharpness of the images. For example, the image processing module is configured to determine the sharpness of the images, and the criterion is fulfilled if the sharpness exceeds a threshold value. The sharpness can be determined by means of well known methods, for example, by measuring the contrasts in the image. The contrast is equivalent to the sharpness. The contrast can be determined by measuring and comparing color values of pixels in the image. The image with the greatest difference between the color values of the pixels has the largest contrast and accordingly the best focus. The images that fulfill the criterion are selected from the sequence of images, and a new image is created based on the selected images. The control module 12 is configured to display the new image on the display unit.

Alternatively, all images that do not fulfill a minimum sharpness criterion are discarded. The image processing module uses information from the selected images to create a new improved image that fulfills the criterion. Preferably, the image processing module is configured to analyze the images based on the criterion and to selects parts of the images that best fulfill the criterion, and to create a new image based on the selected parts from the images.

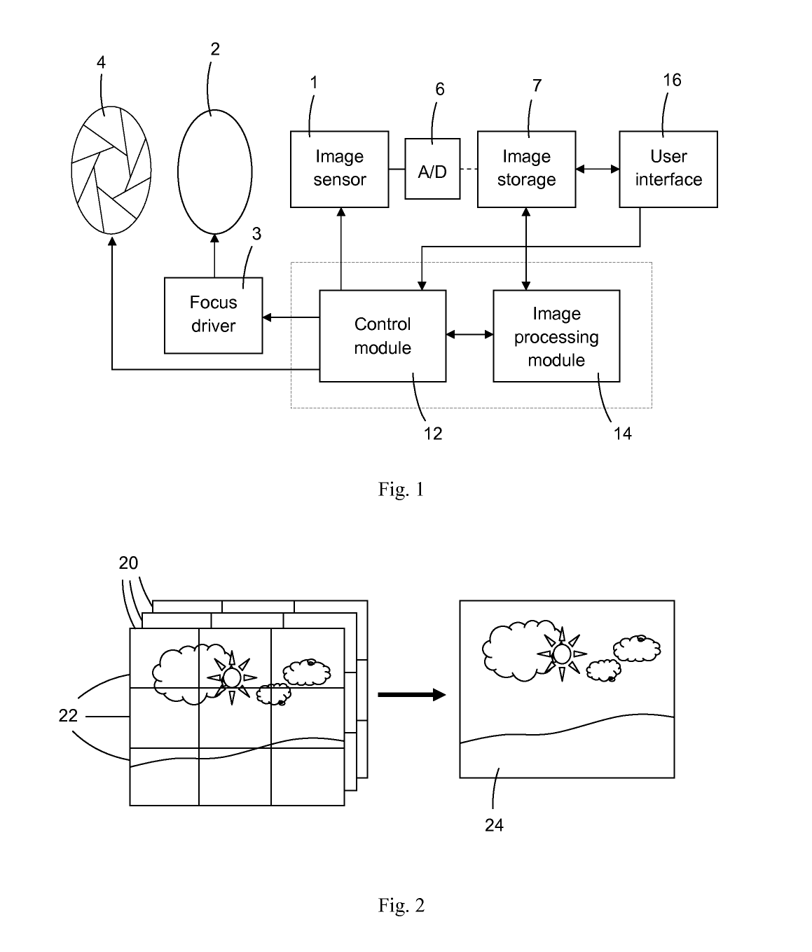

In one embodiment, the image processing module 14 is configured to divide each of the images in the sequence of captured images into a plurality of image portions. For example, each of the images in the sequence is divided into a number of equally sized image portions to form a mosaic of image portions, as shown in FIG. 2. The images are divided into equally number of image portions. Preferably, each image is divided into at least nine image portions. More preferably, each image is divided into at least sixteen image portions. Corresponding image portions disclosing the same part of the scene form a group of image portions. FIG. 2 shows an example including a sequence of three images 20 captured at three different focus ranges. Each image is divided into nine image portions 22, and accordingly there are nine groups of image portions. Since the number of images in the sequence is three, each group includes three image portions.

Each of the image portions are evaluated with regard to the defined criterion. The criterion may include selecting the sharpest image portion among corresponding image portions from each group of image portions. The image processing module is then configured to determine the sharpness of each of the portions, to compare the image portions within each group with regard to the sharpness of the portions, and to select the sharpest image portion from each group. As for the example shown in FIG. 2, nine image portions are selected since there are nine groups of image portions. The selected image portions 22 are put together to form a new image 24 showing the same scene as the original images 20, as shown in FIG. 2. Thus, a new image is created based on the selected images portions. Since the new image is created based on the sharpest image portions, the new image with high probability is sharper than any of the images in the sequence of images.

In on embodiment, the image processing module 14 is configured to determine the sharpness of each image portions and to assign the image portion a weight factor in dependence on the determined sharpness. The image portions are then selected and combined into the new image with regard to the weight factors. For example, the weight factor may vary between 0 and 100, where 100 is the sharpest possible image. Thus, the higher weight factor, the shaper is the image portion. One possible criterion is to select the image portion with the highest weigh factor in each group. Then, an image with high sharpness can be created. Alternatively, the image portions are selected so that the highest sharpness is achieved in the center of the image and the sharpness is decreasing towards the edges of the image. Thus, it is possible to provide an image with high sharpness in the center of the image and decreasing sharpness towards the edges of the image. The image portions can also be selected and combined based on the weight factors so that differences in sharpness between adjacent image portions are minimized. Adjacent images are selected with about the same weight factor to avoid visible differences in sharpness between portions of the image.

Alternatively, the image processing module is configured to select one image from each group based on a minimum criterion for the sharpness. The first image in the group that fulfills the sharpness criterion is selected. This means that not necessarily all of image parts in a group have to be analyzed and compared, and accordingly the embodiment is faster and requires less computer power than the above described criterion.

In on embodiment, the image processing module 14 is configured to evaluate and select the images while capturing the sequence of images. For example, the image processing module is configured to start dividing the captured image into image portions and to determine the sharpness of each image portions of the image as soon as the image is captured and before all images have been captured in order to save time.

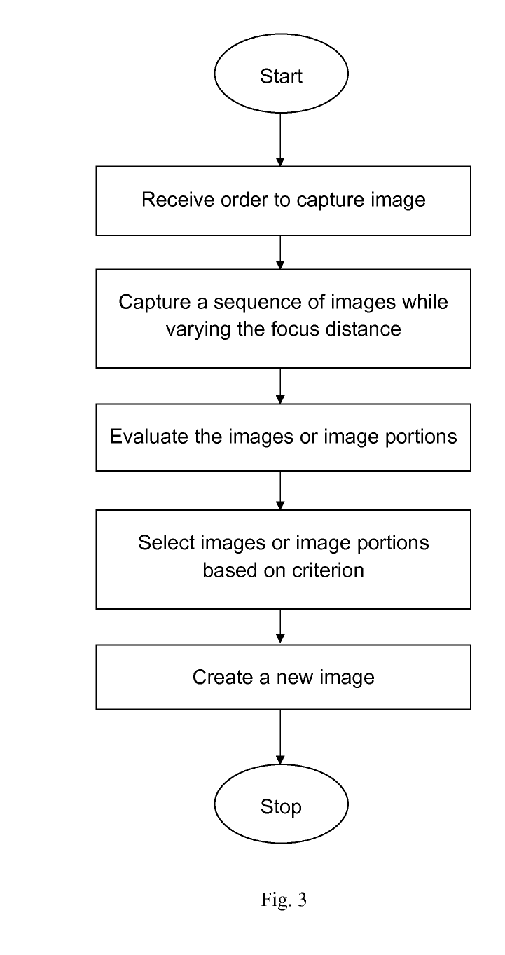

FIG. 3 is a flow chart illustration of an example of a method and a computer program product according to the present invention. It will be understood that each block of the flow chart can be implemented by computer program instructions running on hardware of the data processing system 10.

The camera waits for an order from a user to capture an image. In response to receiving the order, block 30, a sequence of images of the same scene is captures while varying the focus distance between a first and a second focus distance, block 32. The order to capture an image is, for example, received by the user interface 16. The control module 12 is notified when the user interface 16 receives the order to capture an image. Upon being notified by the user interface, the control module 12 orders the focus driver 3 to move the lens 2 from a first focus range to a second focus range and at the same time orders the image sensor 1 to capture a plurality of images while the lens 2 is moved from between the first and second focus range. The captured sequence images are stored in the image storage 7. The stored sequence of images is evaluated with regard to a defined criterion, block 34. For example, the images are evaluated base on their sharpness. It is also possible to evaluate individual portions of the images, as described above. A plurality of images or image portions are selected from the sequence of images based on the result of the evaluation and the defined criterion, block 36. A new image is created based on information from the selected images or image portions, block 38. For example, selected image portions from different images in the sequence are put together to form a new image. The new image is stored in the image storage and is displayed to the user. It is suitable to replace the stored sequence of images with the new image in order to save memory.

In some embodiments, the camera system is configured to enable replacing a section of a first image, or a first image portion, with a corresponding section of a second image or second image portion. For example, the first image or first image portion may be the one selected based on the criterion, such as sharpness, and the second image or second image portion may be unselected. Where the criterion comprises sharpness, the first image or portion may be the sharpest image or portion, and the second image or portion may be the second-sharpest, for example. Replacing the section may be useful in case the selected image or portion comprises a defect, which may be corrected by replacement from the corresponding section of the second image or portion. A defect may occur due to noise in an image sensor, for example.

Replacing the section may take place automatically, in case the camera system is configured to identify defects, and/or responsive to user inputs via a user interface. To enable this, the second image or portion may be retained at least temporarily. The camera system may be configured to discard the second image or portion after using it for replacing. A defect may be determined to exist by comparing pixel values comprised in a surface, for example. In case an individual pixel deviates from surrounding pixels in a non-continuous way, this pixel may be determined to be a defect. For example, a surface for the purpose of defect detection may be determined in connection with determining sharpness so that edges identified for evaluating sharpness define the contours of surfaces.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A digital camera system comprising:
an image sensor for capturing digital images,
an optical unit for forming an image onto the image sensor, the optical unit having a focus distance that can be varied between a minimum focus distance and a maximum focus distance,
a control module for controlling the image sensor and the optical unit,
a image processing module for processing captured images, and
an image storage for storing captured images,
the control module is configured to, upon receiving an order to capture an image, order the image sensor to capture a sequence of images while varying the focus distance between a first and a second focus distance and to store, at least in part, the sequence of captured images in the image storage; and
the image processing module is configured to evaluate said sequence of images with regard to a sharpness, to select at least part of at least one image from said sequence of images based on the result of the evaluation, and to determine the sharpness of the images based on determining whether the sharpness exceeds a threshold value.

2. The digital camera system according to claim 1, wherein the image processing module is configured to select a plurality of images from said sequence of images based on the result of the evaluation and sharpness and to create a new image based on the selected images.

3. The digital camera system according to claim 1, wherein the image processing module is configured to divide at least some of the images in said sequence of captured images into a number of image portions, to evaluate the image portions with regard to sharpness, to select image portions based on the result of the evaluation, as soon as the image is captured and before all images in the sequence have been captured, and to create a new image based on the selected image portions.

4. The digital camera system according to claim 3, wherein the image processing module is configured to compare corresponding image portions of the images in the sequence with regard to the sharpness of the portions, and said criterion includes selecting the sharpest image portion of the compared corresponding image portions.

5. The digital camera system according to claim 1, wherein the image processing module is configured to divide each of said images into a number of portions to form a mosaic of image portions, and to put the selected images portions together to form a new image.

6. The digital camera system according to claim 1, wherein the number of images in the sequence is at least three, and each image is divided into at least nine image portions .

7. The digital camera system according claim 1, wherein the image processing module is configured to determine the sharpness of said image portions, to assign each image portion a weight factor in dependence on the determined sharpness, and to select the image portions in dependence on the weight factors.

8. The digital camera system according to claim 1, wherein the image processing module is configured to evaluate and select the images while capturing the sequence of images.

9. The digital camera system according to claim 1, wherein the image processing module is configured to replace a section of the selected image with a corresponding section from a non-selected image.

10. The digital camera system according to claim 9, wherein the image processing module is configured to replace the section of the selected image responsive to a determination that the section in the selected image comprises a defect.

11. The digital camera system according to claim 9, wherein the image processing module is configured to replace the section of the selected image responsive to user input.

12. A method for controlling a digital camera system comprising an image sensor for capturing digital images and an optical unit for forming an image onto the image sensor, the optical unit having a focus distance that can be varied between a minimum focus distance and a maximum focus distance, the method comprising:
capturing a sequence of images while varying the focus distance between a first and a second focus distance;
evaluating said sequence of images with regard to a defined criterion;
selecting at least one image from said sequence of images based on the result of the evaluation, and
determining the sharpness of the images based on determining whether the sharpness exceeds a threshold value.

13. The method according to claim 12, wherein the method further comprises:
dividing at least some of the images in said sequence of captured images into a number of image portions, evaluating the image portions with regard to sharpness, selecting image portions based on the result of the evaluation, as soon as the image is captured and before all images in the sequence have been captured, and creating a new image based on the selected image portions

14. The method according to claim 12, wherein the method comprises:
selecting a plurality of images from said sequence of images based on the result of the evaluation and said criterion;
creating a new image based on the selected images; and
displaying the new image to a user.

15. The method according to claim 12, wherein the method further comprises: replacing a section of the selected image with a corresponding section from a non-selected image.

16. The digital camera system according to claim 15, wherein the image processing module is configured to replace the section of the selected image responsive to a determination that the section in the selected image comprises a defect.

17. The digital camera system according to claim 15, wherein the image processing module is configured to replace the section of the selected image responsive to user input.
